(19) United States
(12) Patent Application Publication
(10) Pub. No.: US 2012/0092627 A1
(43) Pub. Date: Apr. 19, 2012

(54) LAMP UNIT AND VIDEO PROJECTOR INCLUDING LAMP UNIT

(75) Inventor: Kazuya Minami, Hirakata-shi (JP)

(73) Assignee: SANYO ELECTRIC CO., LTD., Osaka (JP)

(21) Appl. No.: 13/270,636

(22) Filed: Oct. 11, 2011

(30) Foreign Application Priority Data
Oct. 13, 2010 (JP) 2010-230903

(51) Int. Cl. G03B 21/16; H01J 7/26

(52) U.S. Cl. 353/61; 313/35

(57) ABSTRACT

A lamp unit includes a lamp holder that holds a lamp, which includes an arc tube, and a connector, which includes a cable connected to the lamp to supply power to the lamp. A wall member partitions a space formed between the lamp holder and the arc tube. The cable is arranged between the wall member and the lamp holder.

### CROSS-REFERENCE TO RELATED APPLICATIONS

This application is based upon and claims the benefit of priority from prior Japanese Patent Application No. 2010-230903, filed on Oct. 13, 2010, the entire contents of which are incorporated herein by reference.

### BACKGROUND ART

The present invention relates to a lamp unit and a video projector including a lamp unit.

A typical projector includes a lamp unit. The lamp unit includes a lamp, a lamp holder, and a connector. The lamp includes an arc tube. The lamp holder holds the lamp. The connector is connected to the lamp by cables and arranged in the lamp holder. Japanese Laid-Open Patent Publication No. 2003-287812 describes a prior art example of a projector.

The projector described in the above publication includes a light source device. The light source device includes a connector, which is provided with cables, a light source lamp, a reflector, and a lamp housing. The lamp housing includes a connector receptacle and a terminal fastening portion. The connector receptacle accommodates the connector. The cables are fastened by screws to the terminal fastening portion.

To increase the layout freedom of the connector and to facilitate the arrangement of the lamp and the connector in the lamp holder, it is preferable that the cables connecting the lamp and the connector be long and flexible.

However, long and flexible cables may come into contact with the arc tube. A cable tie may be used to bind the cables so that the cables do not contact the arc tube. However, the heat and ultraviolet light generated by the arc tube may deteriorate the cables as well as the cable tie.

### SUMMARY OF THE INVENTION

One aspect of the present invention is a lamp unit provided with a lamp holder that holds a lamp, which includes an arc tube, and a connector, which includes a cable connected to the lamp to supply power to the lamp. A wall member partitions a space formed between the lamp holder and the arc tube. The cable is arranged between the wall member and the lamp holder.

A further aspect of the present invention is a video projector provided with a lamp including an arc tube, a cable connected to the lamp to supply power to the lamp, a connector including the cable, and a lamp unit. The lamp is used as a light source for displaying an image. The lamp unit includes a lamp holder, which holds the lamp and the connector, and a wall member, which partitions a space formed between the lamp holder and the arc tube. The cable is arranged between the wall member and the lamp holder.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIGS. 1A and 1B are perspective views showing a projector according to one embodiment of the present invention;

FIGS. 2A and 2B are perspective views showing a lamp unit of the projector;

FIGS. 3A and 3B are perspective views showing a lamp of the lamp unit;

FIGS. 4A and 4B are perspective views of a lamp housing functioning as a lamp holder;

FIG. 5A is a plan view showing the lamp housing;

FIGS. 5B and 5C are side views showing the lamp housing;

FIG. 5D is a bottom view showing the lamp housing;

FIG. 6 is a perspective view showing the lamp housing with a lamp holding fixture;

FIG. 7 is a perspective view showing a state in which the lamp is fastened by the lamp holding fixture;

FIG. 8 is a perspective view showing how an outer frame member is coupled to the lamp housing;

FIG. 9 is a perspective view of a wall member arranged in the lamp housing;

FIG. 10 is a perspective view showing how the wall member is coupled to the lamp housing;

FIG. 11 is a bottom view showing the lamp unit; FIG. 12 is a partial cross-sectional view of the lamp unit taken along line A-A in FIG. 11;

FIG. 13 is a schematic cross-sectional view showing the flow of air that cools cables in the projector;

FIG. 14 is a perspective view showing a modification of a wall member; and

FIG. 15 is a cross-sectional view showing a state in which the wall member shown in FIG. 14 is coupled to a lamp housing.

### DETAILED DESCRIPTION OF THE INVENTION

A projector 1 serving as one embodiment of a video projector will now be described with reference to the drawings. In the description hereafter, upward and downward directions will be indicated by arrow Z in the drawings. The upward and downward directions are not limited to the vertical direction. Further, forward and rearward directions, which are orthogonal to the upward and downward directions, are indicated by arrow X in the drawings. Further, leftward and rightward directions, which are orthogonal to the upward and downward directions and the frontward and rearward direction, are indicated by arrow Y in the drawings.

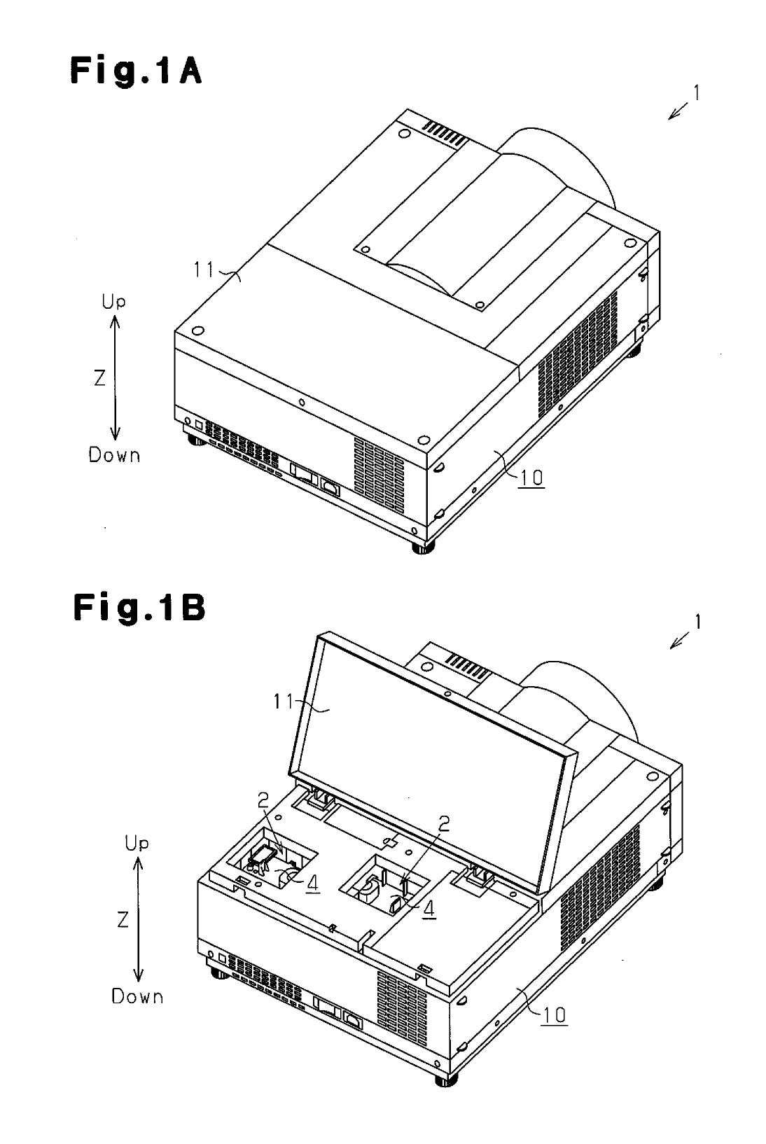

Referring to FIGS. 1A and 1B, the projector 1, which projects and displays an image on a screen, a wall, or the like, includes a case 10, which accommodates electronic components, optical components, or the like. A lamp cover 11 is arranged on the case 10 to open and close the case 10.

The lamp cover 11 may be held in an open state as shown in FIG. 1A or a closed state as shown in FIG. 1B. As shown in FIG. 1B, a lamp unit 2 is arranged in the case 10. When the lamp cover 11 is in the open state, the lamp unit 2 may be removed from or attached to the case 10. In other words, the lamp unit 2 may be replaced by a new one when the lamp cover 11 is in the open state.

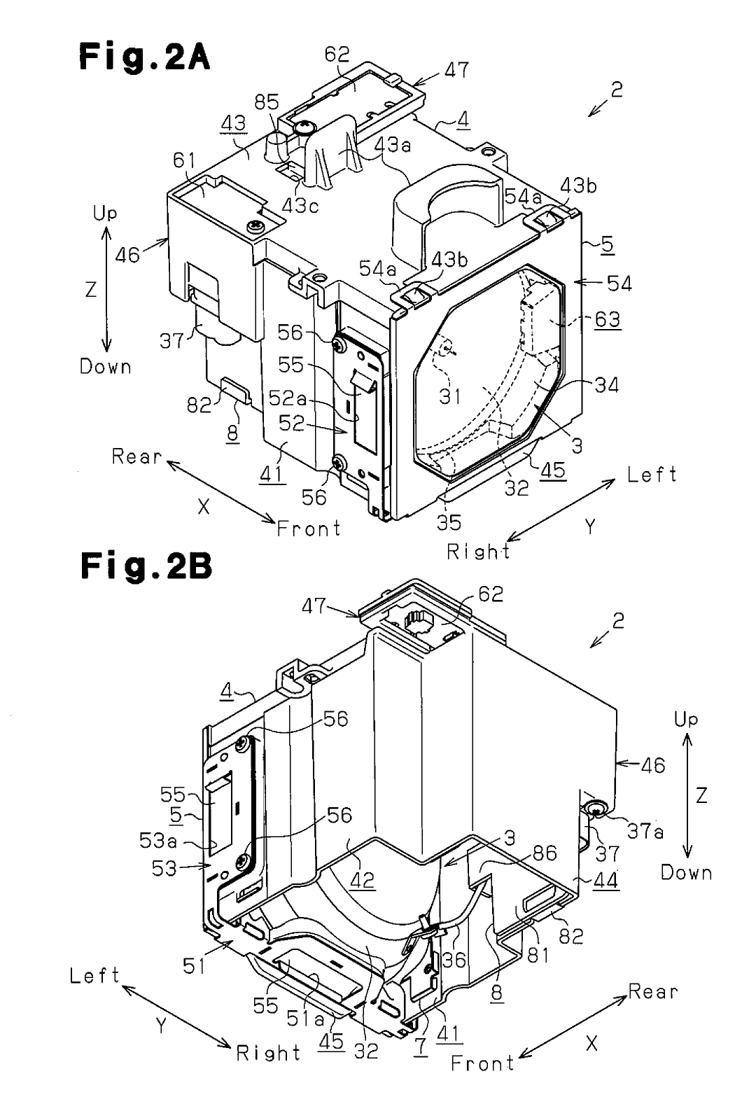

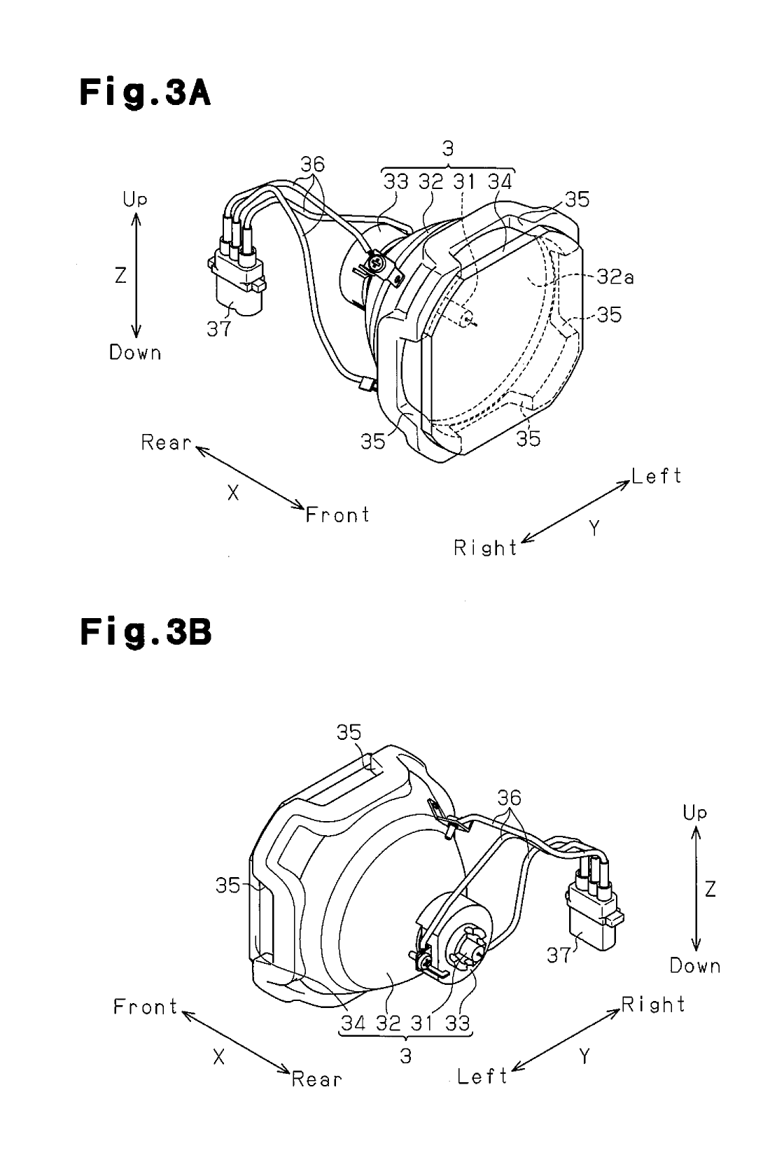

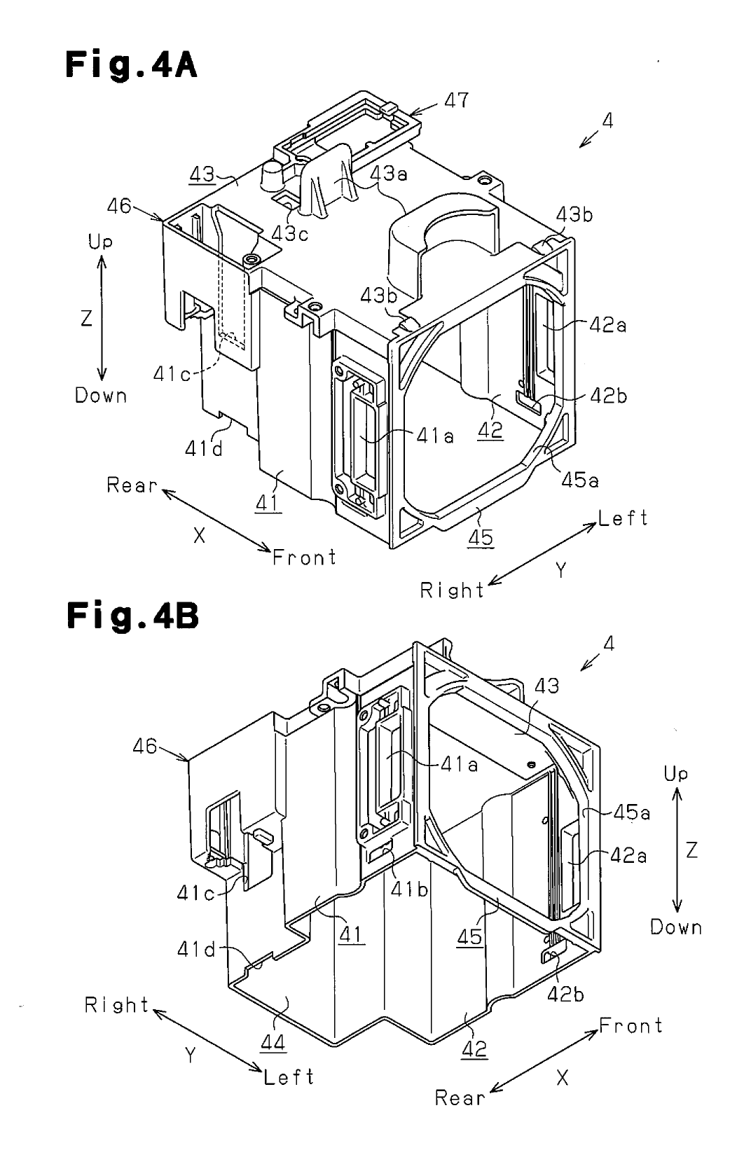

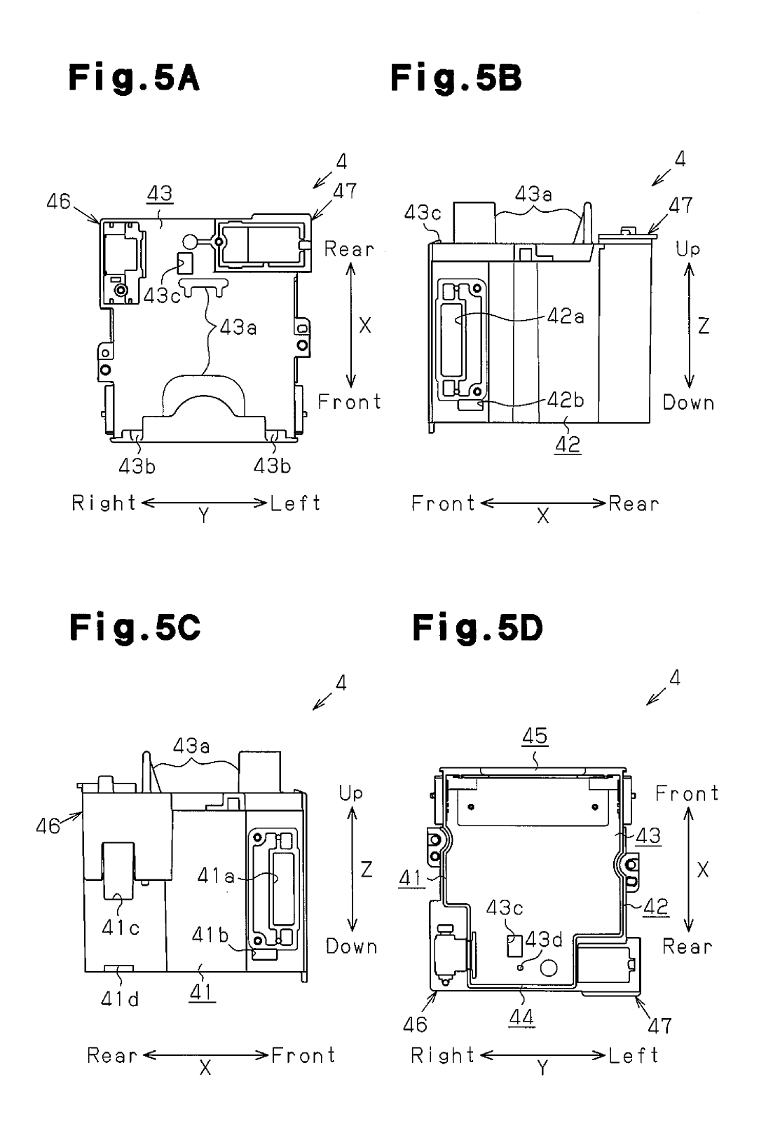

As shown in FIGS. 2A and 2B, the lamp unit 2 includes a box-shaped lamp housing 4, which accommodates a lamp 3. FIGS. 3A and 3B are perspective views showing the lamp 3 in a state removed from the lamp housing 4 shown in FIGS. 2A and 2B. FIGS. 4A, 4B, and 5A to 5D show only the lamp housing 4.

Referring to FIGS. 3A and 3B, the lamp 3, which is a light source for displaying images, is, for example, a discharge lamp. The lamp 3 includes an arc tube 31, which generates light through an electric discharge, a reflector 32, which reflects the light emitted from the arc tube 31 toward the front, an arc tube support 33, which supports the arc tube 31, and a cover glass 34, which is arranged at the front end of the reflector 32.

A luminous body, which is, for example, a mixture or mercury and a halogen gas or halide, is sealed in the arc tube 31. Electric power is supplied to the lamp 3 to apply high voltage to the luminous body sealed in the arc tube 31. This causes a breakdown in the arc tube 31 and generates an electric discharge. In this manner, when an electric discharge is generated in the arc tube 31, the lamp 3 emits light. The arc tube 31 has a shape that is elongated in the forward and rearward directions. The arc tube 31 is partially fitted into the reflector 32. For example, the arc tube 31 has a central portion and front portion arranged in the reflector 32 and a rear portion projected out of the reflector 32.

The reflector 32 is a reflection mirror, which reflects the light emitted from the arc tube 31, and encompasses the arc tube 31. The reflector 32 is arranged to surround the arc tube 31. Further, the reflector 32 includes an inner surface 32a that reflects the light emitted from the arc tube 31 in the reflector 32 toward the front. The inner surface 32a of the reflector 32 is formed by, for example, a paraboloid or an ellipsoid. The light emitted from the arc tube 31 outside the reflector 32, that is, the light emitted from the rear side of the arc tube 31, is emitted toward the rear of the lamp 3 and not reflected toward the front.

The arc tube support 33 is located outside the reflector 32 and arranged on the rear side of the reflector 32. The arc tube support 33 supports the rear side of the arc tube 31 and fixes the arc tube 31 to the reflector 32.

The cover glass 34 is arranged at the front side of the reflector 32 to cover the reflector 32 and the arc tube 31. When the arc tube 31 breaks, the cover glass 34 arranged in front of the arc tube 31 prevents fragments of the arc tube 31 from being scattered. Further, as shown in FIG. 3A, the front end of the reflector 32 includes cutouts that form inlets 35 with the cover glass 34. In the present embodiment, the inlets 35 are arranged at the upper, lower, left, and right sides of the lamp 3.

Cables 36 are connected to the lamp 3 to supply the lamp 3 with power from a power supply circuit (not shown) arranged in the case 10 shown in FIG. 1. The cables 36 are, for example, fixed to the reflector 32 by screws as shown in FIG. 3A and to the arc tube support 33 by a screw as shown in FIG. 3B. Each cable 36 is a flexible cord formed by an electric wire and an insulator that covers the electric wire. Further, each cable 36 has one end connected to the lamp and another end connected to a connector 37. The cable 36 has sufficient length for fixing the corresponding connector 37 to the lamp housing 4 at a predetermined position.

When the lamp unit 2 is placed in the case 10, the connector 37 is connected to a connector (not shown) arranged in the case 10. This electrically connects the power supply circuit in the case 10 to the cables 36 and allows power to be supplied to the lamp 3 to generate electric discharge in the arc tube 31. Although not shown in the drawings, the arc tube 31 includes an electrode, which is used to generate an electric discharge, and an electrode wire, which is connected to the electric wires of the cables 36.

Referring to FIGS. 4A and 4B, the lamp housing 4, which accommodates the lamp 3, is formed to cover the right, left, upper, and rear sides of the lamp 3. More specifically, the lamp housing 4 includes a right wall 41, a left wall 42, an upper wall 43, and a rear wall 44. The right wall 41 and left wall 42 are spaced apart in the leftward and rightward directions. The upper wall 43 connects the right wall 41 and left wall 42. As shown in FIG. 4B, the rear wall 44 connects the right wall 41, left wall 42, and upper wall 43. Further, the lamp housing 4 includes a front wall 45 that connects front ends of the right wall 41, left wall 42, and upper wall 43. The front wall 45 also includes an opening 45a. The light emitted from the lamp 3 accommodated in the lamp housing 4 travels out of the lamp housing 4 through the opening 45a.

The structure of the walls 41 to 45 of the lamp housing 4 will now be described with reference to FIGS. 5A to 5D.

As shown in FIG. 5C, the right wall 41 has a front portion including a circulation port 41a and a fixture hooking hole 41b, which extend through the lamp housing 4. Further, the right wall 41 has a rear portion including an opening 41c. The right wall 41 also has a bottom portion including a groove 41d, which is a recess. As shown in FIG. 5B, in the same manner as the right wall 41, the left wall 42 also includes a circulation port 42a and a fixture hooking hole 42b, which extend through the lamp housing 4.

As shown in FIG. 5A, the upper wall 43 includes a grip 43a used by an operator to hold the lamp housing 4 when replacing the lamp unit 2. As shown in FIG. 5B, the grip 43a is projected upward from the lamp housing 4. Further, the upper wall 43 has a front portion including outer frame hooking projections 43b and a rear portion including an opening 43c, which extends through the lamp housing 4. As shown in FIG. 5D, the rear portion of the upper wall 43 also includes a threaded hole 43d arranged inside the lamp housing 4.

As shown in FIG. 5D, the rear wall 44 and the front wall 45 are spaced apart from each other in the forward and rearward directions. The lamp 3 has a front end, which is pressed against the front wall 45, and a rear end, which is spaced apart from the rear wall 44 even when the lamp 3 is accommodated in the lamp housing 4. This allows one to insert a hand or a tool into the gap between the lamp 3 and rear wall 44.

As shown in FIG. 5A, a connector fastening portion, or connector receptacle 46, is arranged in the rear right portion of the lamp housing 4, and a substrate seat 47 is arranged in the rear left portion of the lamp housing 4. As shown in FIG. 4A, the interior of the connector receptacle 46 is in communication with the interior of the lamp housing 4 through the opening 41c. The interior of the connector receptacle 46 and the interior of the substrate seat 47 open in the upward and downward directions.

The lamp housing 4 functions as a lamp holder that fastens and holds the lamp 3 therein. As shown in FIG. 2A, an outer frame member 5 is arranged on the front end of the lamp housing 4 to prevent separation of the lamp 3 from the lamp housing 4. Further, a receptacle lid 61 is fastened to by a screw to the rear end of the lamp housing 4 to cover the upper opening of the connector receptacle 46. An IC chip 62 is placed on the substrate seat 47 and fastened by a screw to the rear portion of the lamp housing 4. The IC chip 62 functions as a circuit substrate that stores information related with the lamp unit 2.

As shown in FIG. 2B, a lamp holding fixture 7, which holds the lamp 3, is arranged in the lamp housing 4 between the front and rear ends of the lamp housing 4. Further, a wall member 8 is arranged at an inner rear end of the lamp housing 4.

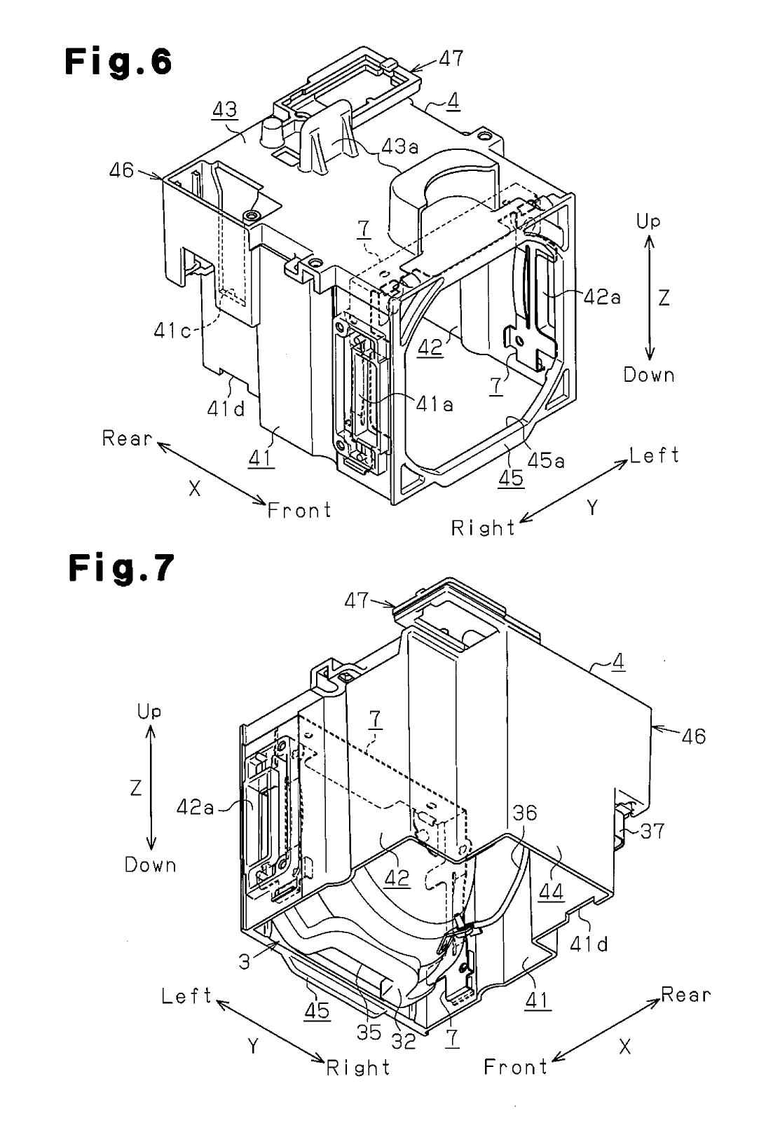

The procedures for assembling the lamp unit 2 will now be described with reference to FIGS. 6 to 10.

Referring to FIG. 6, the lamp holding fixture 7 is arranged in the lamp housing 4 before accommodating the lamp 3. The lamp holding fixture 7 has two ends received in the fixture hooking holes 41b and 42b shown in FIGS. 5C and 5B. This fastens the lamp holding fixture 7 to the lamp housing 4.

As shown in FIG. 7, the lamp 3 is then fitted from below into the lamp housing 4, to which the lamp holding fixture 7 has been fastened. In the lamp housing 4, the lamp holding fixture 7, which functions as a plate spring, presses the reflector 32 of the lamp 3 from opposite sides. After the lamp 3 is held pressed by the lamp holding fixture 7 in a suitable manner, the connector 37 is fitted into the connector receptacle 46. The cables 36 connected to the connector 37 are extended through the opening 41c shown in FIG. 6.

When the lamp 3 is accommodated in the lamp housing 4, the circulation port 42a of the lamp housing 4 shown in FIG. 6 is aligned with the inlet 35 formed in the left side of the lamp 3 shown in FIG. 3A. In the same manner, the circulation port 41a of the lamp housing 4 shown in FIG. 6 is aligned with the inlet 35 formed in the right side of the lamp 3 shown in FIG. 3A.

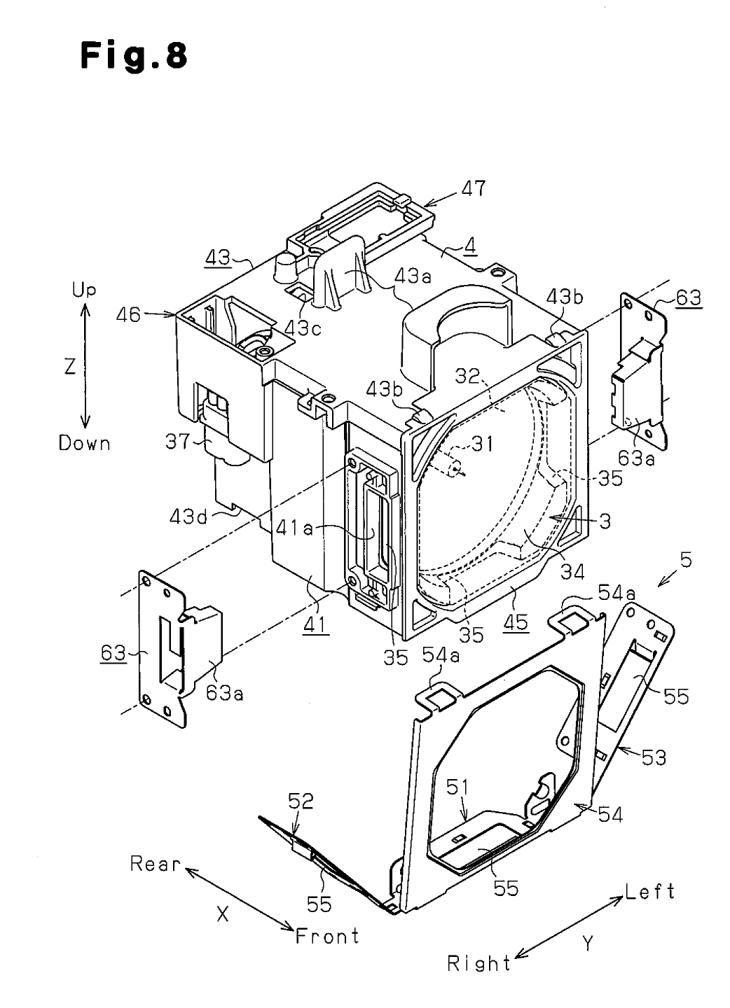

As shown in FIG. 8, the outer frame member 5 is attached to the lamp housing 4 after the lamp 3 is accommodated in the lamp housing 4. In the present embodiment, two deflection plates 63a are arranged on the lamp housing 4. One of the deflection plates 63a is fitted through the circulation port 41a of the lamp housing 4 and arranged in the left inlet 35 of the lamp 3. The other deflection plate 63a is fitted through the circulation port 42a of the lamp housing 4 and arranged in the left inlet 35 of the lamp 3. The deflection plates 63a function as deflectors 63. After the deflection plates 63a are arranged in the lamp housing 4, the outer frame member 5 is attached to the lamp housing 4.

The deflectors 63, or the deflection plates 63a, are formed from metal plates. Each deflection plate 63a extends into the lamp 3 through the corresponding inlet 35. In the present embodiment, the deflection plates 63a arranged on opposite sides of the lamp 3 guide cooling air into the lamp 3 through the left and right inlets 35 of the lamp 3.

In the same manner as the deflectors 63, the outer frame member 5 is also formed from a metal plate. The outer frame member 5 includes a basal portion 51, a right frame portion 52, a left frame portion 53, and a tetragonal frame portion 54. The basal portion 51 is formed by a flat plate member extending in the leftward and rightward directions. The right frame portion 52 is connected to the right end of the basal portion 51 and bendable relative to the basal portion 51. The left frame portion 53 is connected to the left end of the basal portion 51 and bendable relative to the basal portion 51.

The tetragonal frame portion 54 is connected to the front end of the basal portion 51 and bent upward from the basal portion 51. The tetragonal frame portion 54 has an upper end bent rearward to form hooking sections 54a. The hooking sections 54a are hooked to outer frame hooking projections 43b arranged on the front side of the upper wall 43 of the lamp housing 4.

As shown in FIG. 2B, the basal portion 51 includes an opening 51a. The opening 51a is aligned with the lower inlet 35 of the lamp 3. In the same manner as the basal portion 51, the left frame portion 53 includes an opening 53a. As shown in FIG. 2A, the right frame portion 52 also includes an opening 52a. The opening 52a is aligned with the right inlet 35 of the lamp 3, and the opening 53a is aligned with the left inlet 35 of the lamp 3.

A grid 55 is arranged in each of the openings 51b, 52a, and 53a. The grid 55 is formed, for example, from a metal mesh, and fixed to the outer frame member 5 by performing spot welding. When the arc tube 31 breaks, the grid 55 prevents fragments of the arc tube 31 from scattering outside the lamp unit 2.

As shown in FIGS. 2A and 2B, the right frame portion 52 and left frame portion 53 are fixed by screws 56 to the lamp housing 4. The screws 56 also fix the current deflectors 63 to the lamp housing 4 together with the right frame portion 52 and the left frame portion 53. After coupling the outer frame member 5 to the lamp housing 4, as shown in FIG. 2A, the receptacle lid 61 and the IC chip 62 are arranged on the lamp housing 4. Further, as shown in FIG. 2B, the connector 37 is fastened by a screw 37a to the lamp housing 4.

As shown in FIG. 2B, after the connector 37 is coupled to the connector receptacle 46, the wall member 8 is coupled to the lamp housing 4. The wall member 8 is formed from, for example, a resin having superior heat insulating and UV screening characteristics, such as liquid crystal polymer (LCP).

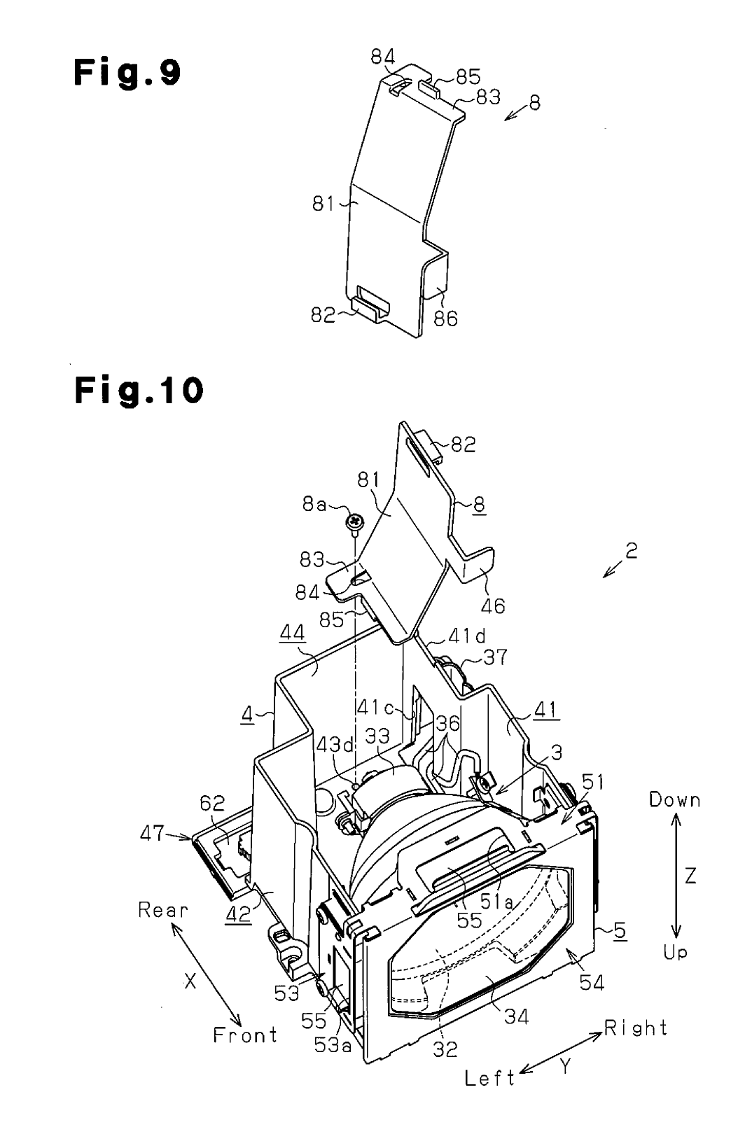

As shown in FIG. 9, the wall member 8 includes a partition 81, a hook 82, and a flap 83. The partition 81 partitions the interior of the lamp housing 4. The hook 82 is hooked to the groove 41d shown in FIG. 5C. The flap 83 is arranged in contact with the upper wall 43 of the lamp housing 4 shown in FIG. 5D. The wall member 8 further include a hole 84, which extends through the wall member 8, and a projection 85, which is fitted in the opening 43c shown in FIG. 5D. The hole 84 and the projection 85 are arranged on the flap 83. The wall member 8 further includes a hooking tab 86 used to hook the cables 36 shown in FIG. 7.

As shown in FIG. 10, the wall member 8 is coupled to the lamp housing 4 with the flap 83 located at the upper side and the hooking tab 86 located at the front side. The wall member 8 is coupled to the lamp housing 4 by inserting a screw 8a through the hole 84 and fastening the screw 8a to the threaded hole 43d of the lamp housing 4. In this manner, the wall member 8, which is discrete from the lamp housing 4, is fastened by the screw 8a to the lamp housing 4.

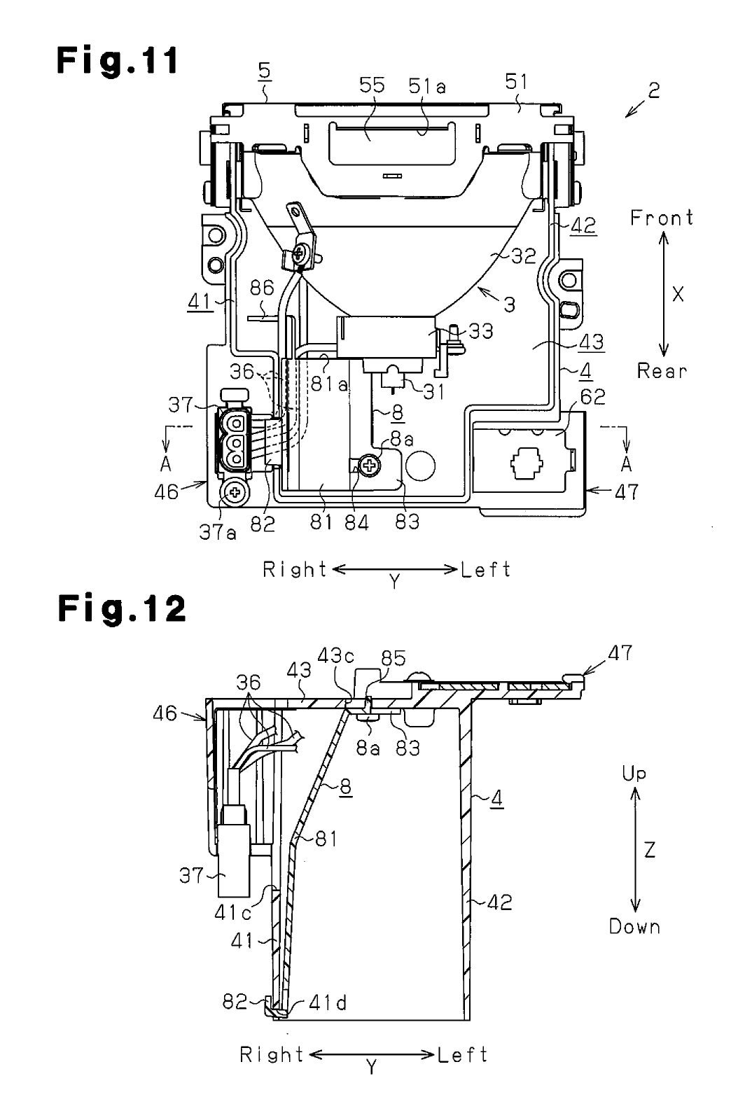

FIG. 11 is a bottom view of the lamp unit 2 showing a state in which the wall member 8 has been coupled to the lamp housing 4. FIG. 12 is a cross-sectional view of the lamp housing 4 and the wall member 8 taken along line A-A in FIG. 11.

As shown in FIG. 11, the wall member 8 covers the cables 36 to shield the cables 36 from the light emitted by the arc tube 31, which is exposed from the rear side of the lamp 3. To shield the cables 36 from light, the partition 81 has a front end 81a located frontward from the exposed portion of the arc tube 31 in the lamp housing 4.

As shown in FIG. 12, the hook 82, which is arranged on the lower end of the wall member 8, is hooked to the groove 41d, which is arranged in the lower end of the lamp housing 4. The projection 85, which is formed on the upper end of the wall member 8, is fitted into the opening 43c formed in the lamp housing 4. In this manner, the wall member 8, which is coupled to the lamp housing 4, covers the opening 43c from the lower side and the opening 41c from the leftward side.

The partition 81, which extends in the upward and downward directions, partitions the interior the lamp housing 4 in the leftward and rightward directions. A cross-section parallel to the leftward and rightward directions shows the cables 36 arranged in a space formed at the right side of the partition 81 and the arc tube 31 arranged in a space formed at the left side of the partition 81. In this manner, the wall member 8 partitions the space between the lamp housing 4 and the arc tube 31, and the cables 36 are arranged in the space formed between the wall member 8 and the inner wall of the lamp housing 4.

The projector 1 that includes the lamp unit 2 uses the lamp 3 to display an image. For example, the projector 1, which includes liquid crystal panels, passes the light emitted from the lamp 3 through the liquid crystal panels to generate an image and project the image onto a screen or the like for display. When the life of the lamp 3 ends and the lamp 3 can no longer be illuminated, the lamp unit 2 is replaced with a new one to replace the lamp 3 with a new one.

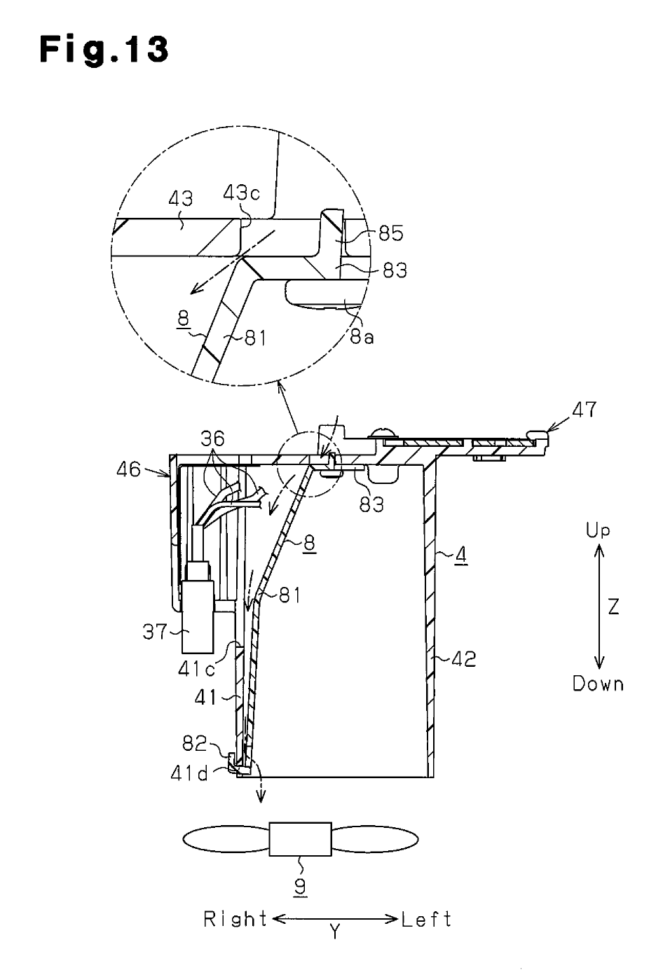

In the present embodiment, as shown in FIG. 13, a fan 9 is arranged below the lamp unit 2 in the case 10 shown in FIG. 1. The fan 9 is driven to produce a flow of air in the case 10. The arrows shown in FIG. 13 indicate the flow of air produced by the fan 9.

When the fan 9 is driven, negative pressure is produced in the lamp housing 4. This draws ambient air into the lamp housing 4 through the opening 43c. The air flows along the wall member 8 and produces a current that positively cools the cables 36.

The fan 9 is driven to cool the cables 36. The fan 9 also positively discharges cooling air out of the lamp 3 through the lower inlet 35. The fan 9 also sends some of the air drawn through the opening 43c into the lamp housing 4 to the rear side of the lamp 3 for cooling. The wall member 8 defines the space in which the lamp 3 is arranged in the lamp housing 4. Thus, the wall member 8 improves the cooling efficiency of the lamp 3.

The lamp unit 2 of the embodiment has the advantages described below.

(1) The lamp unit 2 is provided with the lamp 3, which includes the arc tube 31, the connector 37, which includes the cables 36 connected to the lamp 3 to supply power to the lamp 3, and the lamp housing 3, which holds the lamp 3 and the connector 37. The wall member 8 partitions the space formed between the lamp housing 4 and the arc tube 31. This arranged the cables 36 between the wall member 8 and the lamp housing 4. In this structure, the wall member 8 reduces deterioration of the cables 36 that would be generated by the heat and ultraviolet light generated by the arc tube 31. The wall member 8 also prevents the cables 36 from coming into contact with the arc tube 31.

(2) The wall member 8 is fastened to the lamp housing 4 in a removable manner. The wall member 8 is fixed to the lamp housing 4 and prevented from being separated from the lamp housing 4.

(3) The wall member 8 is fastened by the screw 8a to the lamp housing 4. This rigidly fastens the wall member 8 to the lamp housing 4. Further, by unfastening the screw 8a, the wall member 8 can be removed from the lamp housing 4.

(4) The lamp housing 4 includes the openings 41c and 43c, which extend through the lamp housing 4. The wall member 8 covers the openings 41c and 43c. Thus, the wall member 8 prevents the light emitted from the arc tube 31 from leaking out of the lamp housing 4 through the openings 41c and 43c.

(5) The projector 1, which is a video projector, includes the lamp unit 2, which is used as a light source for displaying an image. When the life of the lamp 3 ends and the lamp 3 can no longer be illuminated, the lamp unit 2 can be replaced with a new one.

(6) The projector 1 includes the fan 9, which produces a flow of air. The wall member 8 forms a passage for the flow of air produced by the fan 9. This effectively cools the cables 36 as compared to when the wall member 8 is eliminated. In particular, the lamp housing 4 of the present embodiment includes the opening 43c. Further, the temperature in the lamp housing 4 is high. Thus, by drawing air into the lamp housing 4 through the opening 43c, the cables 36 are further effectively cooled.

(7) The wall member 8 defines the space in which the lamp 3 is arranged in the lamp housing 4. The wall member 8 also improves the cooling efficiency of the lamp 3. This effectively cools the cables 36 as compared to when the wall member 8 is eliminated.

It should be apparent to those skilled in the art that the present invention may be embodied in many other specific forms without departing from the spirit or scope of the invention. Particularly, it should be understood that the present invention may be embodied in the following forms.

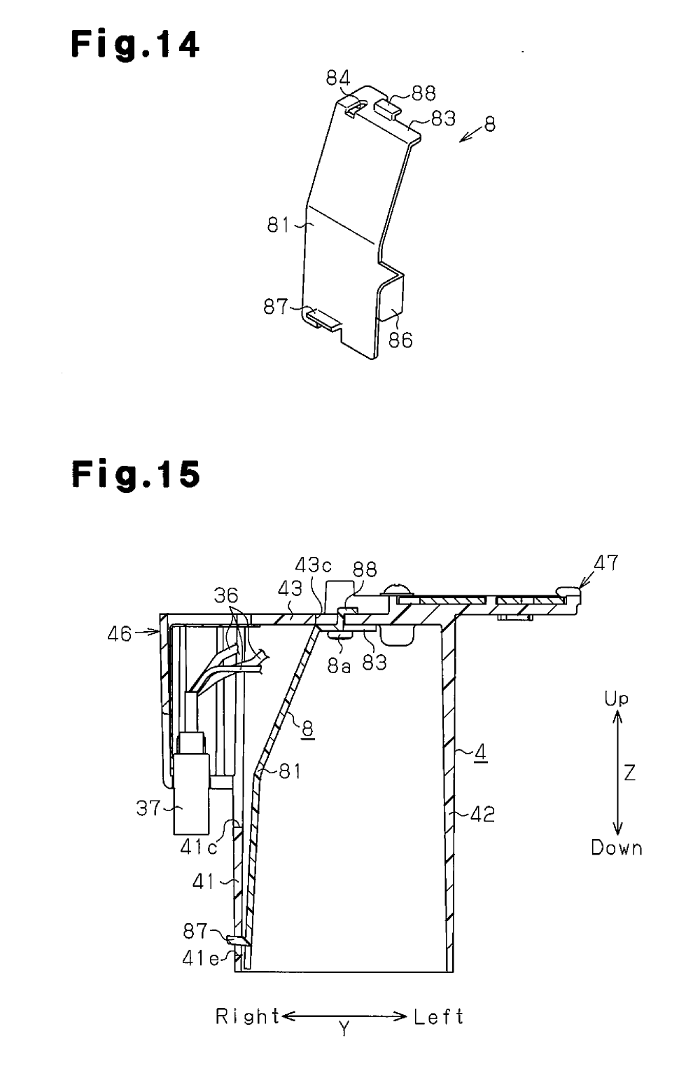

The shape of the wall member 8 may be changed. For example, as shown in FIG. 14, the wall member 8 may include a projection 87 in lieu of the hook 82, and a hook 88 in lieu of the projection 85. Such a wall member 8 can also be arranged in the lamp housing 4 in the same manner as the above embodiment.

Further, the shape of the lamp housing 4 may be changed as shown in FIG. 15. Here, the right wall 41 of the lamp housing 4 includes a hole 41e extending through the lamp housing 4 in lieu of the groove 41d shown in FIG. 12. In FIG. 15, the projection 87 of the above modification is fitted into the hole 41e, and the hook 88 of the above modification is hooked to the opening 43c.

In this manner, the structure used to couple the wall member 8 to the lamp housing 4 may be changed. Further, the screw 8a does not have to be used as longs as the wall member 8 can be fastened to the lamp housing 4.

In the above embodiment, the wall member 8 covers the openings 41c and 43c to prevent light emitted by the arc tube 31 from leaking out of the lamp housing 4. However, the wall member 8 may cover just one of the openings 41c and 43c formed in the lamp housing 4 as long as the light emitted from the arc tube 31 can be prevented from leaking out of the lamp housing 4.

The shape of the wall member 8 may be changed as long as deterioration of the cables 36 caused by the heat and ultraviolet light produced by the arc tube 31 can be prevented and contact of the cables 36 with the arc tube 31 can be prevented. For example, the shape of the wall member 8 may be changed in accordance with the location of the arc tube 31 in the lamp housing 4, the shape of the lamp housing 4, the location at which the connector 37 is accommodated, and the locations of the openings formed in the lamp housing 4.

In the above embodiment, the lamp housing 4 is box-shaped to accommodate the lamp 3 and the connector 37. However, the lamp holder does not have to be box-shaped. In other words, the lamp holder does not necessarily have to accommodate the lamp 3 as long as it can hold the lamp 3.

The video projector is not limited to the projector 1, which generates an image by passing light through liquid crystal panels. For example, the present invention may be applied to a projector that generates an image by selectively reflecting light using a digital micromirror device (DMD).

The present examples and embodiments are to be considered as illustrative and not restrictive, and the invention is not to be limited to the details given herein, but may be modified within the scope and equivalence of the appended claims.

1. A lamp unit comprising:
a lamp holder that holds a lamp, which includes an arc tube, and a connector, which includes a cable connected to the lamp to supply power to the lamp; and
a wall member that partitions a space formed between the lamp holder and the arc tube, wherein the cable is arranged between the wall member and the lamp holder.

2. The lamp unit according to claim 1, wherein the wall member is fastened to the lamp holder in a removable manner.

3. The lamp unit according to claim 1, wherein
the lamp holder is a lamp housing that accommodates the lamp,
the lamp housing includes an opening extending through the lamp housing, and
the wall member covers at least part of the opening.

4. The lamp unit according to claim 1, wherein the wall member covers the cable at a location where the arc tube is exposed from the lamp.

5. The lamp unit according to claim 1, wherein
the lamp includes an arc tube support covering the arc tube, and
the cable is exposed from the wall member at a location where the arc tube support covers the arc tube.

6. The lamp unit according to claim 1, wherein
the lamp holder includes a connector fastening portion at which the connector is fastened,
the connector fastening portion is arranged adjacent to the arc tube, and
the wall member covers the cable between the connector fastening portion and the arc tube.

7. The lamp unit according to claim 1, wherein the lamp holder includes:
a first opening that draws ambient air to the space in which the cable is arranged; and
a second opening that discharges the air from the space in which the cable is arranged.

8. The lamp unit according to claim 7, wherein the wall member forms a passage for the air flowing from the first opening to the second opening.

9. A video projector comprising:
a lamp including an arc tube, wherein the lamp is used as a light source for displaying an image;
a cable connected to the lamp to supply power to the lamp;
a connector fixed to the cable; and
a lamp unit, wherein the lamp unit includes:
a lamp holder that holds the lamp and the connector; and
a wall member that partitions a space formed between the lamp holder and the arc tube, wherein the cable is arranged between the wall member and the lamp holder.

10. The video projector according to claim 9, further comprising a fan that produces a flow of air, wherein the wall member forms a passage for the flow of air produced by the fan.

11. The video projector according to claim 10, wherein the wall member is formed to improve a cooling efficiency of the lamp.
